(19) United States
(12) Patent Application Publication
(10) Pub. No.: US 2005/0155480 A1
(43) Pub. Date: Jul. 21, 2005

(54) Compound musical instrument string configuration and support system

(76) Inventor: Patterson Martin Joseph, Carlsbad, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/003,627

(22) Filed: Dec. 2, 2004

Related U.S. Application Data
(60) Provisional application No. 60/537,158, filed on Jan. 16, 2004.

(51) Int. Cl. G10D 3/00

(52) U.S. Cl. 84/299

(57) ABSTRACT

An apparatus for doubling of the length of each string of a stringed instrument using two legs of an extended string. The effective longer string length allows for the production of a lower tone range without lengthening the neck of the instrument, or the same tone range while shortening the neck of the instrument. If required to prevent bowing of the neck, a reinforcing structure may be included to the neck structure or in a second preferred embodiment a buttress support to the neck of the instrument may be provided. The height of the paired strings above the fret board may also be adjusted.

This application claims benefit of U.S. provisional patent application No. 60/537,158, filed Jan. 16, 2004. This invention relates to the field of musical instruments whose tones are produced by vibrating strings. These instruments which have strings that are plucked with the finger or a plectrum include the bablaika, banjo, guitar, harp, lute, mandolin, zither, the sitar of India and Pakistan, and the koto of Japan. Others which are plucked by means of a keyboard include the harpsichord and spinet. Still another variety is played with the bow and is principally of the viol and violin families including the kemence of Turkey and Central Asia, the rebab of the Arab world and the many varieties of spike fiddle in Indonesia, central Asia and elsewhere. Instruments whose strings are struck include the dulcimer of Europe and America, the santur of Iran, Iraq, and several keyboard instruments, among them the piano and clavichord.

### FIELD OF THE INVENTION

More specifically the invention relates to a new method of doubling each string of the instrument on itself and having the two legs of an extended string attached by means of a continuous soft flexible coupling material or a rigid clip or grommet adjacent to the bridge. This will produce a lower tone range without lengthening the neck of the instrument or the same tone range while shortening the neck of the instrument. This is done in conjunction with the addition of a buttress support to the neck of the instrument and a means for adjusting the height of the paired strings individually over the frets on the fret board.

### BACKGROUND OF THE INVENTION

This invention describes a new and unique method of using a compound instrument string configuration to produce lower tones on stringed instruments while maintaining or reducing the length of the fretted neck. The addition of a buttress support means adds the strength required when doubling the strings. An additional benefit is that the string diameter does not have to be enlarged to produce the lower tones, thus adding to the comfort of playing the instrument. The inventor's expertise is in the field of electric guitars where he initially devised the idea. Guitars are one of the musical instruments related to the lute. Modern guitars normally have six strings that are plucked with the fingers or strummed with a pick. The guitar body usually has a flat back with sides that curve inward to form a waist of the sound box and a fretted neck portion extending from the body of the instrument. Other forms of the guitar include the 12-stringed steel guitar played with a metal bar to produce a sliding tone, the electric guitar, and the 4 stringed bass guitars, which like the electric guitar is a fixture of rock music and is electronically amplified. Some styles of the guitars being electrically amplified do not require a hollow sound box and have a variety of different shapes. The traditional classical guitar as opposed to electric guitar appeared as early as the 12th century in Spain, the country with which it is particularly associated. It was very popular there in the 16th century when much music was written for it.

The base guitar will often have an extended neck for the length of the strings required to achieve the lower tones of the instrument and is more cumbersome to hold. One of the unique features in this patent is that each string is a compound string, configured in such a way that a longer string is used or two strings that are strongly or rigidly connected in series (end to end). The string or strings form a loop so that the distal ends are held together within the conventional tension adjustor on the neck with the loop end going around a low friction bearing of the retainer on the body of the instrument to maintain equal tension on each leg of the string. The two legs of the string are maintained in close parallel engagement by the means of a soft flexible coupling material. A unique buttress system has been devised to give a greater strength to the neck of the instrument required when the strings are doubled.

In this respect, before explaining at least one embodiment of the invention in detail, it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### REFERENCES CITED

U.S. Pat. No. 3,636,809 of Hideyuki Ezaki describes a stringed musical instrument that comprises one sound box having two sound boards, each provided with a sound hole and a sidewall joining the sound boards, two necks provided for the sound boards respectively, two heads connected to the necks, two seal caps for closing the sound holes, and strings stretched between the heads and the sound boards, whereby musical tones having a variety of tone colors can be produced on both sides of the sound box. This patent describes basically two guitars back to back as one but does not describe the act of the doubling back the string to produce a lower tone range as in the compound string configuration and does not have any similarities to the compound musical instrument string configuration and support system described within this patent.

U.S. Pat. No. 4,078,468 of Simon Civitello discloses an apparatus for extending a lower range of a stringed musical instrument. A stringed musical instrument such as a member of the viol family, in particular a bass viol, having a string with a length longer than the classical length and hence an extended lower range. An extended neck and fingerboard are provided and a clamp at the end of the standard fingerboard releasable clamps the extended string at its classical length when the extended range is no longer needed.

This disclosure provides components and a method for meeting the requirement of adding length to the strings of a musical instruments to produce a lower tone. The disclosed device describes both an apparatus to be added to an existing stringed instrument along with additional reinforcement provided for increase tensional strain, or a body style with components included as a means for strength. Both embodiments allowing for the doubling of the mass of the strings attached to thereby produce a lower tone range of the instrument.

U.S. Pat. No. 4,508,003 of Peter H. Smakula teaches of a truss rod apparatus, for use within the neck of a stringed musical instrument, to correct both concave and convex warping of the instrument's neck. The apparatus includes a first and second rod, the rods lying parallel to each other in a groove within the instrument's neck having the groove and truss rod apparatus overlaid by the fingerboard. The rods are fastened together at one pair of their ends with the opposite end of the first rod fastened to an anchor block, holding the rod axially and radially immobile. The opposite end of the second rod is threaded, engaging with internal threads of a hollow bolt. The hollow bolt itself threads with a passageway through the anchor block. Upon rotation of the bolt, the effective length of the second rod may be increased or decreased without rotating the rod, causing either a concave or convex bow in the rod pair. Where the first and second rod lengths are equal, the rods lay straight, imparting no forces on the instrument neck. The apparatus is easily replaceable without dismantling the instrument's neck.

This patent describes the need to strengthen the neck portion of a stringed instrument in that it has the tendency to bow or twist with undo stresses but does not incorporate the means of using a buttress system.

U.S. Pat. No. 4,606,255 of Yoshiaki Hayashi describes a guitar synthesizer that has a guitar body and a synthesizer portion. The body of the guitar extends toward a head in a direction so that an end serving as a first vibratory member of the body's base to which a neck is connected intersects with the neck. A second end serving as the second vibratory member may also intersect with the neck. A non-vibratory portion is interposed between the first and the second vibratory members. A reinforcing frame is attached to the head and body to interconnect them with the shortest distance for providing a firm connection from the non-vibratory portion of the body to a part of the head closer to a nut than to the head end. Thus, the connection between the head and the frame is located below the central point of the distance between the nut and the top end of the head. Such a structure suppresses vibrations of the neck and an early attenuation of the fundamental frequency due to the vibration of the strings are avoided.

This patent offers what may be interpreted as a single buttress, but it is not used as a means to reduce the size of the neck portion of the instrument for the ease of playing by an individual with small hands and does not incorporate the unique feature of the compound string arrangement.

U.S. Pat. No. 5,485,773 of Terry J. Devitrysmith tells of a mechanism that includes an assembly which fits in a notch in the bottom of the body of a guitar to carry the strings around the bottom in order to allow the guitar to be as short as feasible while having standard effective string lengths. This assembly includes features, which allow independent adjustments for each string of the effective length of the string and distance of the string from its associated electronic pickup. The assembly is made up of a base and six roller assemblies. Each roller assembly carries a string around the bottom of the body. The base has two flanges with six setscrews in each flange and each roller assembly rests on the ends of two setscrews, one in each flange and is held in place by the string. One setscrew adjusts the effective string length, the other the distance of the string from its pickup. The knobs for the tuning machines of the guitar are distributed around the top edge of the front face of the body of the guitar.

This patent does not extend the functional length of the strings from the nose to the bridge. It only extends the non vibrating part of the strings from the knobs. It therefore does not achieve the increased mass of the vibrating portion of the strings or the depth of the tones of the compound musical instrument string configuration and support system described within this patent.

Thus, there is clearly indicated the need in the field of stringed instruments for a new and unique instrument with a lower tone range that is easy to hold and play. This patent also offers the opportunity to reduce the size of existing instruments by using the compound musical instrument string configuration and support system in the design of new instruments.

### SUMMARY OF THE INVENTION

The invention herein disclosed relates to a new method of doubling each string of the instrument on itself and having the two legs of an extended string attached by a continuous soft flexible coupling means or a rigid clip or grommet adjacent to the bridge. This will produce a lower tone range without lengthening the neck of the instrument or the same tone range while shortening the neck of the instrument. This is done in conjunction with the addition of a buttress support to the neck of the instrument and a means for adjusting the height of the paired strings individually over the frets on the fret board.

The unique feature of the strings in this patent is that in a compound string configuration two legs of a single string or the two legs of two strings that are strongly or rigidly connected in series end to end are doubled back on each other. In this configuration the tension is maintained equal in each leg, with the two legs held parallel by the means of a continuous soft flexible coupling material or a rigid clip or grommet adjacent to the bridge of the instrument. This coupling means may be used separately or in combination. The hard coupling of the two legs in series insures that they vibrate at the same frequency with each other. The soft coupling in parallel maintains the vibration in the two legs to be in phase and coherent. The two legs need to be in phase and coherent so that they do not rub against each other and dampen or cancel the vibration amplitude and so that their effective mass is additive. This configuration produces a string with twice the mass of either of the two individual legs and hence produces the lower frequency of vibration as in the base guitar range.

Explained in mathematical terms, the equation that is used to calculate the frequency of vibration of a string fixed at both ends, as is the case for guitar strings, is:
Frequency=(½ L) times the square root of S/U,
where “L” is the length of the string, “S” is the tension in the string, and “U” is the mass per unit length of the string.

To convert the tones of a standard guitar to the tones of a bass guitar the frequency must be reduced by one half, which is one octave lower. When the mass per unit length of a standard guitar string is doubled by coupling two of the same type strings together along their length, calculation shows that the frequency is reduced by approximately one-third. The force required to pluck such a string is twice the force of a single string since one is pushing against the tension of two strings. An optimal condition is obtained by reducing the tension in both strings by one-half.

Calculation now shows that the frequency is reduced to half of the original (standard guitar string) frequency. Further, the force required to pluck the string is now the same as the standard guitar string. Most importantly the length of the string is not changed. This elegant solution results in a bass guitar frequency (tone) with the same string length (and spacing of frets) and playing force of a standard guitar, thereby yielding a bass guitar that plays with ease of a standard guitar or a standard guitar that produces the tones of a base guitar.

An additional advantage of a compound string configuration is that it has a smaller effective diameter in the direction perpendicular to the plane of the fret board. This allows the string to be placed closer to the fret board improving the ease of playing the instrument. Also the compound string can be shorter than a conventional single string length of the same tone. This allows a shorter neck length and closer spacing between the frets. Again these properties are more favorable for ease of playing the instrument. Also the neck size can be reduced in width and thickness further improving the ease of play. With the incorporation of the compound musical instrument string configuration and support system a smaller base guitar with the same scale size of a normal guitar fret board can be accomplished.

The soft flexible coupling of the two legs allows flex between the legs of the string in the direction of their length so that the tension can continuously adjust and maintain equal with a single tension adjuster while the string will self align on the low friction bearing of the retainer. The unique design of the bridge maintains the two legs of the string parallel and at the same distance from the plane of the fret board. The soft flexible coupling means must be adequate to maintain the two legs vibrating in phase and coherent. An adequate soft flexible coupling is required to keep the fundamental frequency and its higher harmonics in phase and coherent to insure the quality of the tone.

To permit the compound string to perform as described above, a special bridge assembly is required that will allow the two legs of the string to flex independently in opposite directions when initially installed and when tuned. The two legs of the string rest on two separate low friction bearings spaced by a thin washer type spacer installed on the bridge. The low friction bearings are used to insure that the tension of the two separate legs of the strings will self adjust and are matched. The two legs of the strings are connected around a third bearing on the string retainer that allows the tension in the two legs to be matched at all times by allowing them to pull against each other in opposite directions. Again a low friction bearing is desirable so that any small difference in tension is minimized. The act of playing the instrument actually helps keep the string tension matched by transferring force from the higher tension string leg to the lower tension string leg should an imbalance develop.

The increased stresses on the neck of the instrument by the compound string configuration have been relieved by the addition of a means for reinforcement in the form of one or two buttress members on either side of the neck of the instrument. With the addition of the buttress members, the neck of the instrument will either be the same or may be reduced in size to increase the comfort for those individuals with smaller hands.

An additional refinement which is desirable but not required is the addition of the string height adjustment mechanism to maintain the parallelism of the string legs with relation to the fret board and with added capability of adjusting the height of the strings over the fret board. Without the surface features of the string height adjustment mechanism and the bearing on the bridge, the compound string could have the tendency to twist over the length of the neck of the instrument. Also, the strings are best soft coupled to each other to maintain them in a parallel relationship down their respective lengths and so that tensional matching of the strings may occur without inducing twisting.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

### OBJECTS OF THE INVENTION

An object of the compound musical instrument string configuration and support disclosed is to create a means for having smaller and more compact musical instruments which will produce a lower tone range than conventional instruments of the same size.

Another object of this invention is to have one or more strings of the instrument double back on itself which may be tightened with a single tensioning device.

Another object of this invention is to have the string after doubling back on itself coupled together by the means of a soft flexible polymer or rubber material to allow limited flex to each leg of the string and to synchronize the vibration.

Yet another object of this invention is to have the string double back on itself over a low friction bearing, allowing the string to self center and flex freely.

An additional object of this invention is to have the string after doubling back on itself be coupled together by the optional means using a rigid clip or grommet adjacent to the bridge of the instrument to synchronize the vibration.

Another object of this invention is to maintain the compound instrument string parallel to the fret board between the bridge and the string height adjustment mechanism, not allowing it to twist.

Yet another object of this invention is to have two smaller diameter strings coupled together that are closer to the frets and more comfortable on the fingers to play while still giving the desired tones.

Still another object of this invention is to raise or lower each compound string configuration separately away from the fret board.

A further object of this invention is to create a buttress system to strengthen the neck of the instrument to support the added stresses incurred by doubling the strings.

Another object of this invention is to maintain or even reduce the thickness of the neck of the instrument so that it is easier to play for all individuals especially those with small hands.

A final object of this invention is to refine and develop a new and unique musical instrument along with refining existing musical instruments.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred and alternate embodiments of the invention. There has thus been outlined, rather broadly, the more important features of the invention in order that the detailed description thereof that follows may be better understood and in order that the present contribution to the art may be better appreciated. There are additional features of the invention that will be described hereinafter and which will form the subject matter of the claims appended hereto.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 depicts a plan view of a guitar using the preferred embodiment of the compound musical instrument string configuration and support system.

FIG. 2 depicts a section through the side of the guitar using the preferred embodiment of the compound musical instrument string configuration and support system.

FIG. 3 depicts a cross section through the neck portion of the guitar using the preferred embodiment of the compound musical instrument string configuration and support system.

FIG. 4 depicts a section through a single compound musical instrument string installation.

FIG. 5 depicts a perspective view of the string height adjustment mechanism at the nut or head end of the neck.

FIG. 6 depicts a section through the string height adjustment mechanism in the raised position.

FIG. 7 depicts a section through the string height adjustment mechanism in the lowered position.

FIG. 8 depicts a perspective view of the bridge unit of the compound musical instrument string configuration with the optional height adjustment.

FIG. 9 depicts a perspective view of the alternate embodiment of the string retainer unit of the compound musical instrument string configuration.

FIG. 10 depicts a perspective view of the preferred embodiment of the string retainer unit of the compound musical instrument string configuration affording easy string changes.

### DETAILED DESCRIPTION OF THE PREFERRED EMBODIMENTS

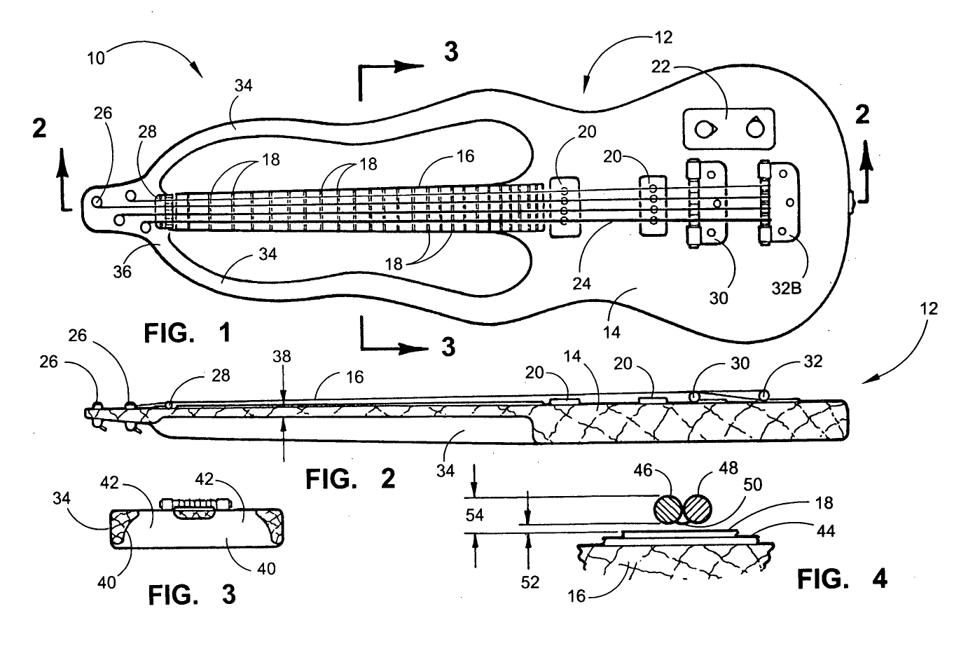

Referring now to the drawings FIGS. 1-10, wherein similar parts of the invention are identified by like reference numerals, there is seen in FIG. 1 a plan view of a stringed instrument such as the depicted electric guitar employing the disclosed compound musical instrument string configuration and support system 10. The compound musical instrument string configuration and support system 10, while illustrated as an electric guitar 12, is equally adaptable for inclusion on any stringed instrument. Consequently, inclusion on any type of stringed instrument is anticipated by this patent application.

Most stringed instruments such as the guitar 12 consist of a lower body unit 14 and a neck 16 portion on which string tensioners 26 are mounted for adjusting the instrument tone. On a guitar 12, the neck 16 features a plurality of frets 18 used as a means to locate the users fingers on the neck to produce different notes when the strings are depressed to the neck 16. Electronic pickups 20 and volume controls 22 are unique to electric instruments only.

As shown, the compound instrument strings 24 are gripped on the distal ends on the conventional tensioners 26 and translate over the string height adjustment mechanism 28 then over the frets 18 to the electronic pickups 20 and over the bridge unit 30 to be held by the string retainer 32B. The string height adjustment mechanism 28, while desirable in the preferred mode of the device, could be an option. A means to strengthen the neck 16 and body 14 engagement to maintain an inline planar engagement of the neck and body when the stings are tensioned is provided in the depicted device as at least one buttress element 34 extending from the upper portion of the neck 36 to the guitar lower body 14. Two buttress elements 34 are shown.

While those skilled in the are will no doubt realize that steel or other reinforcements may be built into the neck 16 and body 14 as a reinforcement means to maintain the inline planar engagement between the two when the strings 24 are tensioned, such reinforcement conventionally adds structure and considerable size to the neck 16. This increase in size results in a neck 16 that is much more difficult for the user to play. Consequently one and preferably two buttresses 34 allow the neck 16 to be sized small for easy play and still provide great strength to the instrument and maintain the neck 16 aligned with the body 14 when the strings are tensioned, and keep the strings in line raised position over the length of the neck and body.

FIG. 2 depicts a section through the side of the guitar 12 using the preferred embodiment of the compound musical instrument string configuration and support system 10 further illustrating the guitar 12 with the lower body unit 14 and a neck 16 with a plurality of frets 18 and the electronic pickups 20 and volume controls 22. In used as a guitar, the compound instrument strings 24 are both attached or gripped on the conventional tensioners 26 at their distal ends, and translate over the string height adjustment mechanism 28, then over the frets 18 down the guitar neck 16 to the electronic pickups 20 and over the bridge unit 30 to be held by the string retainer 32B. This section clarifies the thin cross section 38 required of the guitar neck 16 when the buttress elements 34 are incorporated into the design of the musical instrument.

FIG. 3 depicts a cross section through the guitar neck 16 of the guitar 12 using the preferred embodiment of the compound musical instrument string configuration and support system 10 illustrating the relief's 40 in the buttress elements 34 to add clearance in the areas 42 for the players hands to pass through. Also shown in FIG. 3, is the metal reinforcement 41 which might be used instead of the preferred buttresses 34 as a means to strengthen the neck and body engagement.

FIG. 4 shows a section through a single compound instrument string 24 over a single fret 18 in a fret board 44 on the guitar neck 16. The compound instrument string 24 consists of a first or left leg 46 and a second or right leg 48 doubled back and engaged by the means of a soft flexible polymer or rubber material 50. The clearance 52 of the compound instrument string 24 over the fret 18 is maintained by a means to adjust the clearance of the compound string 24 over the fret in the form of a string height adjustment mechanism 28 allowing for a lower overall height 54 of the compound instrument string 24.

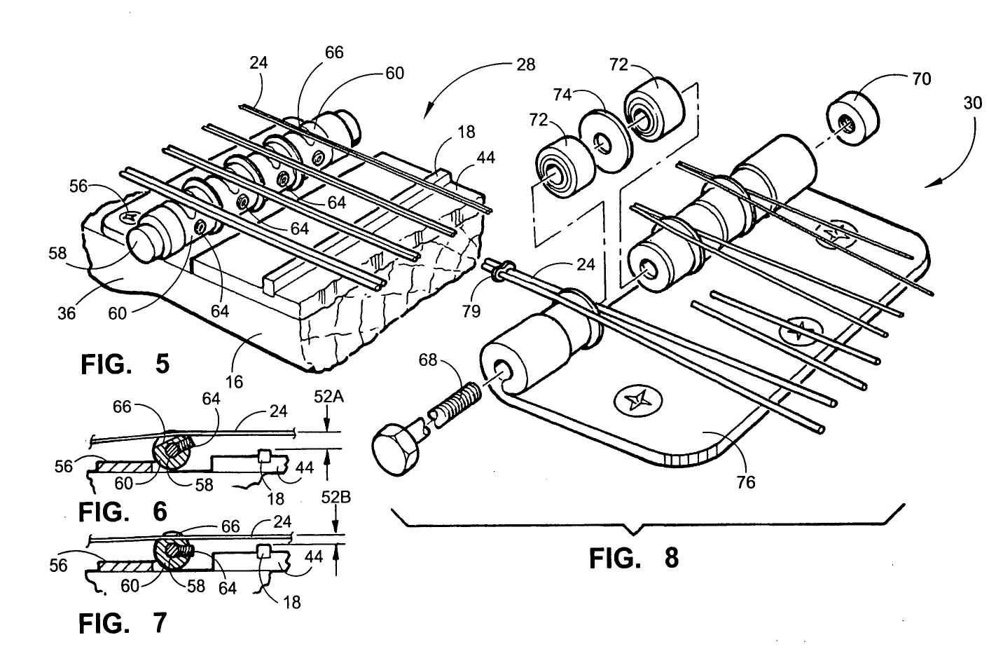

FIG. 5 depicts a perspective view of the string height adjustment mechanism 26 consisting of a mounting plate 56 holding a central shaft 58 and a plurality of height adjustment bushings 60 separated by spacers 62 and held in place by the means of set screws 64. FIG. 6 and FIG. 7 depict sections through the string height adjustment mechanism 28 in the raised position with a clearance of 52A and in the lowered position with a clearance of 52B with the compound instrument string 24 passing through the locating slot 66.

FIG. 8 depicts a perspective view of the bridge unit 30 of the compound musical instrument string configuration and support system 10 showing central shaft 68 with a locking nut 70 and two of the low friction bearings 72 and a thin spacer washer 74 exploded away from a mounting plate 76. The soft flexible polymer or rubber material 50 provides a means to slidably engage the left leg 46 with the right leg 48 of the compound instrument string 24 and is terminated prior to the left leg 46 and the right leg 48 being divided by the thin spacer washer 74.

The separation of the left leg 46 and the right leg 48 at the bridge unit 30 is essential for the left leg 46 to go below the low friction bearing 78 on the string retainer 32A or 32B. Additionally shown in FIG. 8 is a rigid clip or grommet 79 adjacent to the bridge unit 30 of the instrument. One or more of these rigid clips or grommets 79 can be attached to the compound instruments strings 24. This coupling means may be used separately or in combination on the compound musical instrument string configuration and support system 10. The slidable yet fixed coupling of the two legs in series insures that they vibrate at the same frequency with each other yet slip past each other when tensioned if need be.

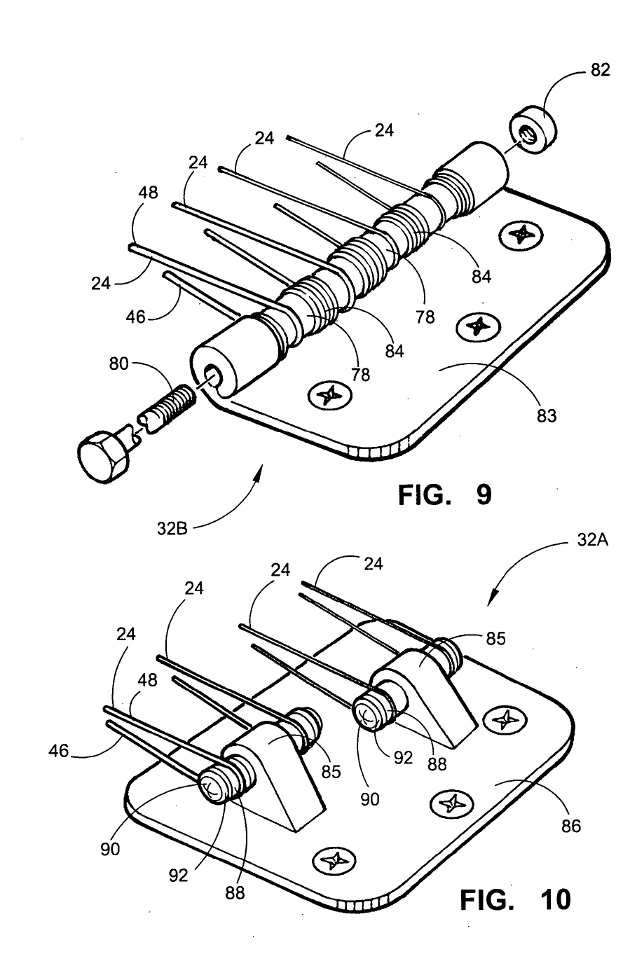

FIG. 9 depicts a perspective view of the alternate embodiment of a means to rotationally engage the end of the string 24 in the form of the string retainer 32B of the compound musical instrument string configuration and support system 10 with a central shaft 80 with a lock nut 82 exploded away from the retainer 32B mounting plate 83 with a polarity of spacers 84 separating the low friction bearings 78. The left leg 46 of the compound instrument string 24 goes below the low friction bearing 78 to double back and become the right leg 48 while staying in alignment with the thin spacer washer 74 of the bridge unit 30.

FIG. 10 depicts a perspective view of another preferred embodiment of the string retainer 32A of the compound musical instrument string configuration and support system 10 with two stanchions 85 attached to a mounting plate 86 with the compound instrument string 24 doubling back around a low friction bearings 88 on each side that is held in place with mounting screw 90 and spacers 92 on either side.

The compound musical instrument string configuration and support system 10 shown in the drawings and described in detail herein disclose arrangements of elements of particular construction and configuration for illustrating preferred and alternate embodiments of structure and method of operation of the present invention. It is to be understood, however, that elements of different construction and configuration and other arrangements thereof other than those illustrated and described may be employed for providing a compound musical instrument string configuration and support system 10 in accordance with the spirit of this invention, and such changes, alternations and modifications as would occur to those skilled in the art are considered to be within the scope of this invention as broadly defined in the appended claims.

Further, the purpose of the foregoing abstract is to enable the U.S. Patent and Trademark Office and the public generally and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

1. An apparatus providing compound musical instrument string configuration on a stringed instrument having a neck and body supporting tensioned strings, comprising:
means for string tensioning adapted for engagement to the distal end of the neck portion of a stringed instrument having said neck portion attached at an attachment end to a body of said stringed instrument;
at least one elongated string having two distal ends and a middle section between said two distal ends;
a string retainer adapted for engagement on said body;
means to engage both said distal ends of said string to said means for string tensioning;
means to rotationally engage a middle segment of said middle section around said string retainer thereby separating said string into a first leg and a second leg extending between said means for tensioning and said means to rotationally engage a segment of said middle section, and
said first leg and said second leg variably tensionable between said distal ends and said middle segment by activation of said string tensioner to concurrently increase or decrease tension on both said first and second leg, thereby holding them in an elevated position adjacent to a playing surface extending along said neck and said body.

2. An apparatus providing compound musical instrument string configuration on a stringed instrument of claim 1 additionally comprising:
means for coupling each respective first leg to each respective second leg.

3. An apparatus providing compound musical instrument string configuration on a stringed instrument of claim 2 additionally comprising said means for coupling each respective first leg to each respective second leg comprises:
a plurality of leg separators, each leg slidably engaged at a first end on said first leg and at a second end on said second leg;
said leg separators maintaining a defined distance between said first and second leg; and
said leg separators allowing for independent lateral translation of each of said first leg and said second leg in their respective engagements with said first end and said second end of said leg separators.

4. An apparatus providing compound musical instrument string configuration on a stringed instrument of claim 1 additionally comprising:
means for adjustment of said elevated position of said first leg and said second leg adjacent to said playing surface.

5. An apparatus providing compound musical instrument string configuration on a stringed instrument of claim 2 additionally comprising:
means for adjustment of said elevated position of said first leg and said second leg adjacent to said playing surface.

6. An apparatus providing compound musical instrument string configuration on a stringed instrument of claim 3 additionally comprising:
means for adjustment of said elevated position of said first leg and said second leg adjacent to said playing surface.

7. An apparatus providing compound musical instrument string configuration on a stringed instrument of claim 1 additionally comprising:
means for translating said first leg and said second leg from a first substantially parallel arrangement in a first plane, to a second substantially parallel arrangement in a second plane, said first plane substantially parallel to said playing surface on said body, said second plane substantially perpendicular to said playing surface.

8. An apparatus providing compound musical instrument string configuration on a stringed instrument of claim 2 additionally comprising:
means for translating said first leg and said second leg from a first substantially parallel arrangement in a first plane, to a second substantially parallel arrangement in a second plane, said first plane substantially parallel to said playing surface on said body, said second plane substantially perpendicular to said playing surface.

9. An apparatus providing compound musical instrument string configuration on a stringed instrument of claim 3 additionally comprising:
means for translating said first leg and said second leg from a first substantially parallel arrangement in a first plane, to a second substantially parallel arrangement in a second plane, said first plane substantially parallel to said playing surface on said body, said second plane substantially perpendicular to said playing surface.

10. An apparatus providing compound musical instrument string configuration on a stringed instrument of claim 4 additionally comprising:
means for translating said first leg and said second leg from a first substantially parallel arrangement in a first plane, to a second substantially parallel arrangement in a second plane, said first plane substantially parallel to said playing surface on said body, said second plane substantially perpendicular to said playing surface.

11. An apparatus providing compound musical instrument string configuration on a stringed instrument of claim 5 additionally comprising:
means for translating said first leg and said second leg from a first substantially parallel arrangement in a first plane, to a second substantially parallel arrangement in a second plane, said first plane substantially parallel to said playing surface on said body, said second plane substantially perpendicular to said playing surface.

12. An apparatus providing compound musical instrument string configuration on a stringed instrument of claim 6 additionally comprising:
means for translating said first leg and said second leg from a first substantially parallel arrangement in a first plane, to a second substantially parallel arrangement in a second plane, said first plane substantially parallel to said playing surface on said body, said second plane substantially perpendicular to said playing surface.

13. An apparatus providing compound musical instrument string configuration on a stringed instrument of claim 1 additionally comprising:
at least one buttress support communicating between said body and said neck to thereby reinforce said neck.

14. An apparatus providing compound musical instrument string configuration on a stringed instrument of claim 2 additionally comprising:
at least one buttress support communicating between said body and said neck to thereby reinforce said neck.

15. An apparatus providing compound musical instrument string configuration on a stringed instrument of claim 3 additionally comprising:
at least one buttress support communicating between said body and said neck to thereby reinforce said neck.

16. An apparatus providing compound musical instrument string configuration on a stringed instrument of claim 4 additionally comprising:
at least one buttress support communicating between said body and said neck to thereby reinforce said neck.

17. An apparatus providing compound musical instrument string configuration on a stringed instrument of claim 7 additionally comprising:
at least one buttress support communicating between said body and said neck to thereby reinforce said neck.

18. An apparatus providing compound musical instrument string configuration on a stringed instrument of claim 1 additionally comprising:
a pair of opposing buttress supports communicating between said body and said neck to thereby reinforce said neck.

19. An apparatus providing compound musical instrument string configuration on a stringed instrument of claim 2 additionally comprising:
a pair of opposing buttress supports communicating between said body and said neck to thereby reinforce said neck.

20. An apparatus providing compound musical instrument string configuration on a stringed instrument of claim 3 additionally comprising:
a pair of opposing buttress supports communicating between said body and said neck to thereby reinforce said neck.
